(19) United States
(12) Patent Application Publication
(10) Pub. No.: US 2005/0283599 A1
(43) Pub. Date: Dec. 22, 2005

(54) Exposing BIOS information to an ACPI aware operating system

(76) Inventors: Toby S. Zimmerman, Cornelius, OR (US); John K. Mathews, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/873,730

(22) Filed: Jun. 22, 2004

(51) Int. Cl. G06F 9/445; G06F 15/177; G06F 9/00; G06F 9/24

(52) U.S. Cl. 713/2

(57) ABSTRACT

A method, system and article of manufacture to expose Basic Input/Output System (BIOS) information to an Advanced Configuration and Power Interface (ACPI) aware operating system. BIOS setup data is copied to an ACPI memory region during a pre-boot phase of a computer system. An operating system on the computer system is booted. The BIOS setup data is accessed during an operating system runtime of the computer system.

### BACKGROUND

1. Field

Embodiments of the invention relate to the field of computer systems and more specifically, but not exclusively, to exposing Basic Input/Output System (BIOS) information to an Advanced Configuration and Power Interface (ACPI) aware operating system.

2. Background Information

Generally, the pre-boot phase is defined as the period of time between computer system startup and the operating system (OS) taking control of the system. At the startup of a typical computer system, the system BIOS is loaded from Read-Only Memory (ROM) and executed. The system BIOS initializes the platform hardware, performs system tests, and prepares the system for the operating system to take control. In one example, the system BIOS will load an OS loader into memory. Beginning the execution of the OS loader marks the end of the pre-boot phase.

When the OS takes control of the system, the period commonly known as OS runtime begins. During OS runtime, the system BIOS may act as an interface between software and hardware components of a computer system. Such interface services include assisting with software interrupts.

Currently, system BIOS information is only available during the pre-boot phase. Typically, in response to the pressing of a hotkey, a BIOS setup utility is presented to the user that shows the settings of the system BIOS. The user may make modifications to the BIOS settings from the BIOS setup utility. However, system BIOS information is not accessible during OS runtime.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating one embodiment of an environment that supports exposing BIOS information to an ACPI aware operating system in accordance with the teachings of the present invention.

FIG. 2 is a flowchart illustrating one embodiment of the logic and operations to expose BIOS information to an ACPI aware operating system in accordance with the teachings of the present invention.

FIG. 3 is a block diagram illustrating one embodiment of an environment that supports exposing BIOS information to an ACPI aware operating system in accordance with the teachings of the present invention.

FIG. 4 is a block diagram illustrating one embodiment of an environment that supports exposing BIOS information to an ACPI aware operating system in accordance with the teachings of the present invention.

FIG. 5 is a block diagram illustrating one embodiment of an environment that supports exposing BIOS information to an ACPI aware operating system in accordance with the teachings of the present invention.

FIG. 6 is a block diagram illustrating one embodiment of an exemplary computer system to implement embodiments of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

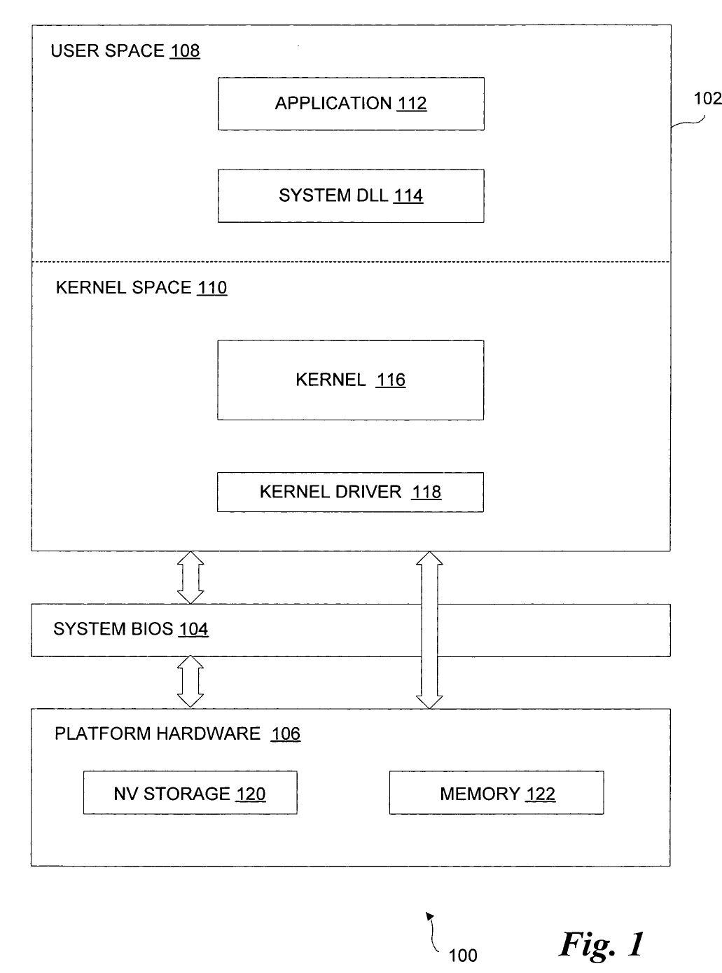

Referring to FIG. 1, one embodiment of a computer system 100 is shown. Computer system 100 includes an operating system (OS) 102 layered on a system BIOS 104. System BIOS 104 is layered on platform hardware 106.

OS 102 includes a user space 108 and a kernel space 110. The operating system environment described herein gives an overview of components common to most operating systems. One skilled in the art will recognize that embodiments of the present invention may be implemented in particular operating systems, such as, but not limited to, Microsoft Windows®, the Apple Macintosh OS, UNIX, Linux, or the like. In one embodiment, OS 102 is an ACPI aware operating system. An ACPI aware OS includes an OS capable of functioning substantially in conjunction with ACPI (discussed further below). The ACPI specification describes an interface to provide OS-directed device configuration and power management of devices and systems (see, Advanced Configuration and Power Interface (ACPI) Specification, Revision 2.0b, Oct. 11, 2002 (available at http://www.acpi.info)).

User space 108 includes an application 112 and a system dynamic linked library (DLL) 114. Kernel space 110 includes a kernel 116 and a kernel driver 118. While only one application 112 is described herein for the sake of clarity, it will be understood the embodiments of the present invention may operate with more than one application executing on computer system 100.

Kernel 116 is generally considered the core of operating system 102. Typically, the kernel 116 performs process management, memory management, file system management, and input/output operations of computer system 100. Because the code that makes up the kernel 108 is needed continuously, it is usually loaded into memory in an area that is protected so that it will not be overlaid with other less frequently used parts of the operating system. Kernel driver 118 allows interaction between operating system 102 and devices of platform hardware 106.

The services of kernel 116 are requested by other parts of the operating system 102 or by application 112 through system calls of the system DLL 114. System calls expose kernel functionality that software components operating on computer system 100 may require.

Generally, DLL's include a set of library procedures and their data structures. An application is usually linked with a number of DLL's, so when the application makes an Application Program Interface (API) call, one of the procedures of a DLL is requested. In one embodiment using a Microsoft Windows® OS, system DLL 114 includes, but is not limited to, the ntdll.dll, kernel32.dll, or the like.

Platform hardware 106 includes non-volatile (NV) storage 120 and memory 122. Embodiments of NV storage 120 include Read-Only Memory (ROM), flash memory, or the like. During the pre-boot phase of computer system 100, firmware instructions that make up system BIOS 104 are loaded from NV storage 120 into memory 120 and executed. During pre-boot, system BIOS 104 initializes platform hardware 106, performs system checks, and prepares the computer system 100 for OS 102 to be loaded.

During OS runtime, system BIOS 104 may provide various services to OS 102 and application 112. In one embodiment, such services include handling interaction with platform hardware 106 and servicing software interrupts from OS 102 and its applications. In the embodiment of FIG. 1, OS 102 may communicate directly with platform hardware 106. OS 102 may also request services from system BIOS 104 and system BIOS 104 subsequently interacts with platform hardware 106.

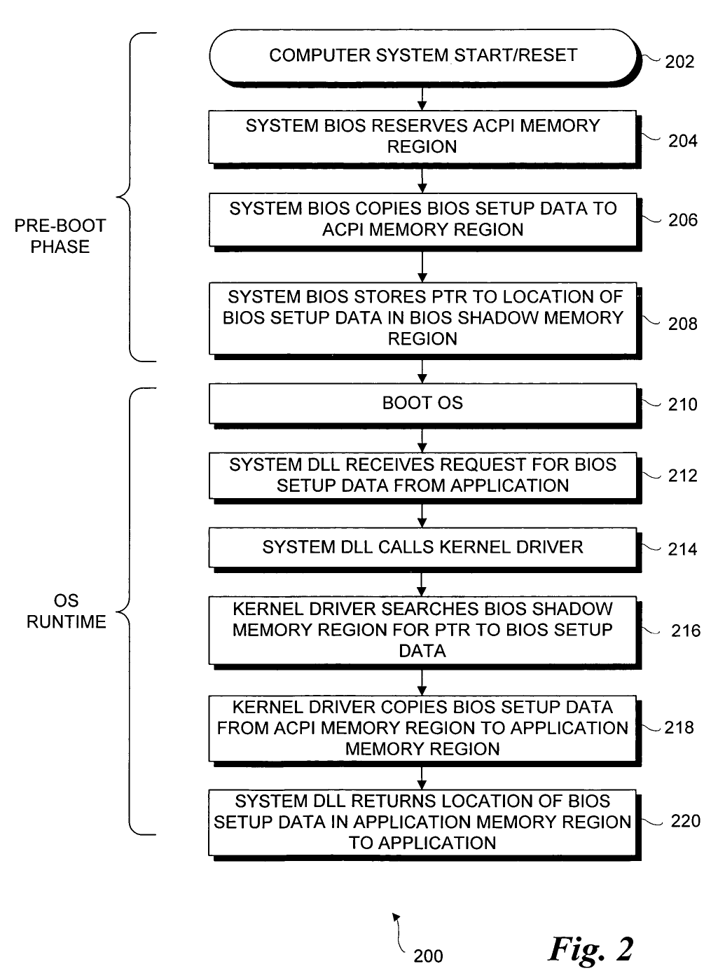

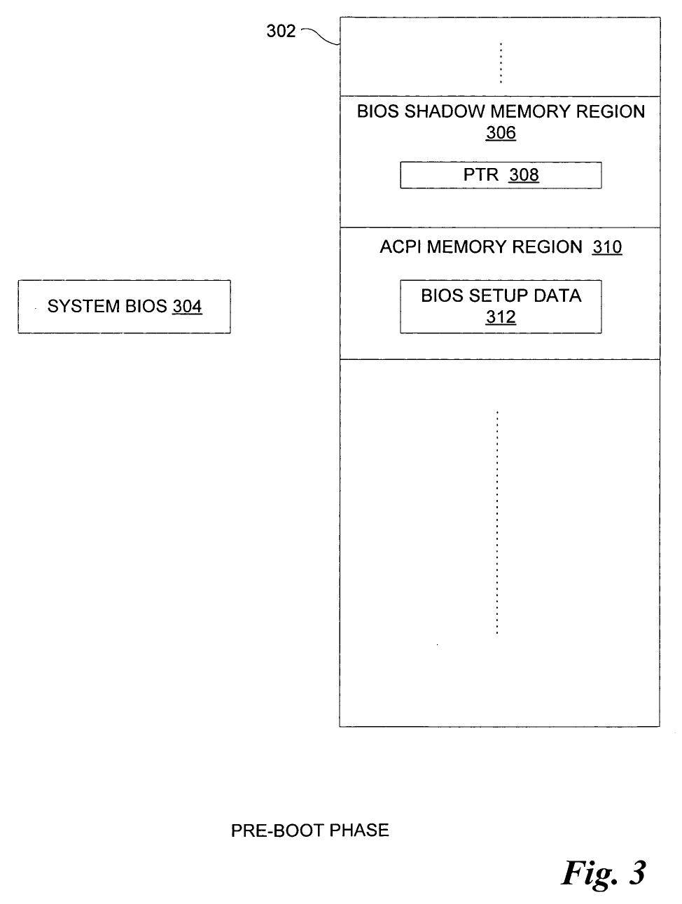

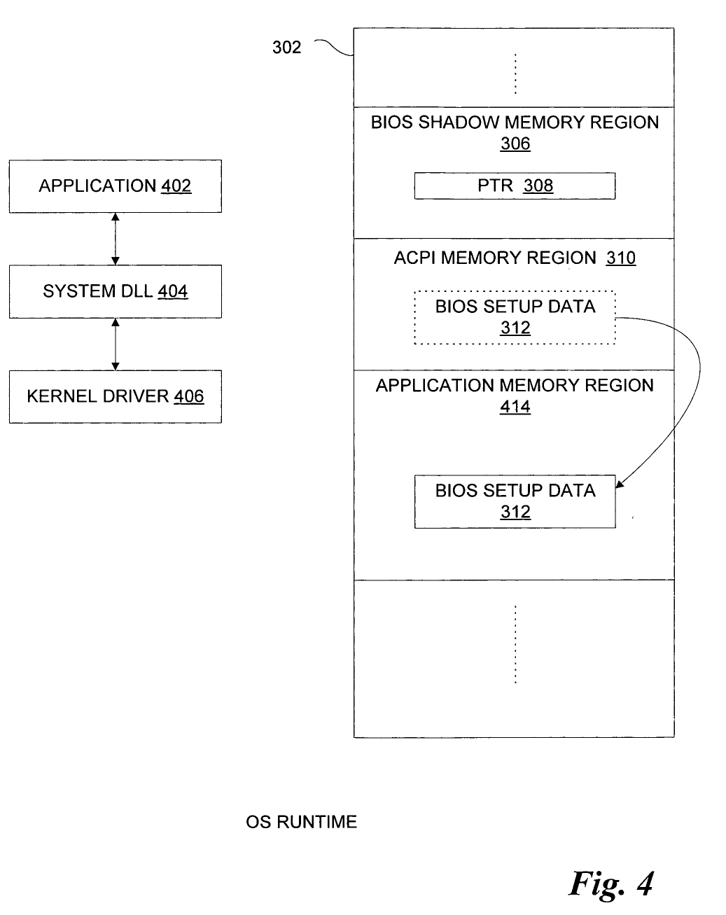

Referring to FIGS. 2, 3, and 4, embodiments to expose BIOS setup data to an ACPI aware operating system will be described. FIG. 2 illustrates a flowchart 200 of one embodiment of the logic and operations to expose BIOS setup data to an ACPI aware operating system of a computer system. FIG. 3 shows an embodiment of a pre-boot phase of the computer system; FIG. 4 shows an embodiment of an OS runtime phase of the computer system.

Referring to FIG. 2, in a block 202, a computer system is started/reset. The system BIOS is loaded from non-volatile storage and executed. In one embodiment, the system BIOS may conduct a Power-On Self-Test (POST) routine.

Continuing to a block 204, the system BIOS reserves an ACPI memory region. Memory resources of an ACPI-compliant system may be allocated for use by ACPI. ACPI memory address range types include AddressRangeMemory (type 1), AddressRangeReserved (type 2), AddressRangeACPI (type 3), and AddressRangeNVS (type 4). Referring to FIG. 3, system BIOS 304 has reserved ACPI memory region 310 of memory 302 during the pre-boot phase.

In one embodiment, the ACPI memory region includes an ACPI Type 4 memory region. ACPI Type 4 memory includes a range of addresses reserved for the system that may not be used by the operating system. According to the ACPI specification, this memory address range is required to be saved and restored across NVS (non-volatile storage) sleep.

Continuing to a block 206, the system BIOS copies BIOS setup data to the ACPI memory region. BIOS setup data includes BIOS settings and information regarding platform hardware that is known by the system BIOS. In one embodiment, BIOS setup data includes platform information known only by the system BIOS, and not normally accessible by the OS. Embodiments of BIOS setup data include, but are not limited to, bus settings (such as Accelerated Graphics Port (AGP) aperture size, Peripheral Component Interconnect (PCI) latency timer, etc.), memory settings (such as memory frequency, memory Column Address Strobe (CAS) latency, memory Row Address Strobe (RAS) to CAS delay, memory RAS precharge, etc.), chipset settings, processor settings (such as central processor unit (CPU) settings), environmental control settings (such as fan speed, temperature cooling ranges, etc.), or the like.

Referring to FIG. 3, system BIOS 304 has copied BIOS setup data 312 to ACPI memory region 310. In one embodiment, BIOS setup data 312 is approximately 64 kilobytes in size.

Proceeding to a block 208, the system BIOS stores a pointer to the location of the BIOS setup data in a BIOS shadow memory region. Generally, a BIOS shadow memory region is a portion of memory that stores the contents of ROM containing the system BIOS. This allows the computer system to access system BIOS faster since generally, random access memory (RAM) is faster to read than read-only memory (ROM), or other forms of non-volatile storage. In one embodiment, the BIOS shadow memory region is at memory address F0000h to FFFFFh of system memory.

In FIG. 3, a pointer 308 has been stored in a BIOS shadow memory region 306. In one embodiment, the pointer 308 includes a signature. The signature identifies the pointer as referring to the location of the BIOS setup data 312.

Continuing to a block 210 in flowchart 200, the operating system of the computer system is booted. Generally, when the operating system takes control of the computer system, this marks the beginning of OS runtime.

In a block 212, a system DLL receives a request for BIOS setup data from an application. Continuing to a block 214, the system DLL calls a kernel driver. In a block 216, the kernel driver searches the BIOS shadow memory region for the pointer. In one embodiment, the kernel driver searches for the signature identifying the pointer.

Referring to FIG. 4, application 402 calls system DLL 404 requesting BIOS setup data for the computer system. In turn, system DLL 404 calls kernel driver 406. Kernel driver 406 searches BIOS shadow memory region 306 for pointer 308. After finding the pointer 308, the kernel driver 406 follows pointer 308 to the start address of the BIOS setup data 312 in the ACPI memory region 310.

Proceeding to a block 218 of FIG. 2, the kernel driver copies the BIOS setup data from the ACPI memory region to an application memory region. As shown in FIG. 4, kernel driver 406 copies the BIOS setup data 312 from ACPI memory region 310 to application memory region 414. Application memory region 414 includes an area of memory 302 available to application 402 and system DLL 404. In one embodiment, application memory region 414 may only be accessed by application 402 and system DLL 404. In a block 220, the system DLL returns the location of the BIOS setup data in the application memory region to the application.

It will be understood that embodiments of the present invention are not limited to the arrangement of memory 302 as described herein and shown in FIGS. 3 and 4. Further, embodiments of memory regions 306, 310, and 414 may be contiguous regions, sparse regions, or any combination thereof.

In one embodiment, application 402 includes the Intel® Desktop Control Center (IDCC). The IDCC enables a user to analyze and customize the configuration of a computer system. In one embodiment, the IDCC may be used to customize boards such as Intel® Desktop Boards D865PERL, D875PBZ, or the like. In one embodiment, the IDCC does not have built-in assumptions about the configuration of a platform, but provides a generic interface that may be employed across a variety of systems. Once installed on a system, the IDCC is provided BIOS setup data as described herein.

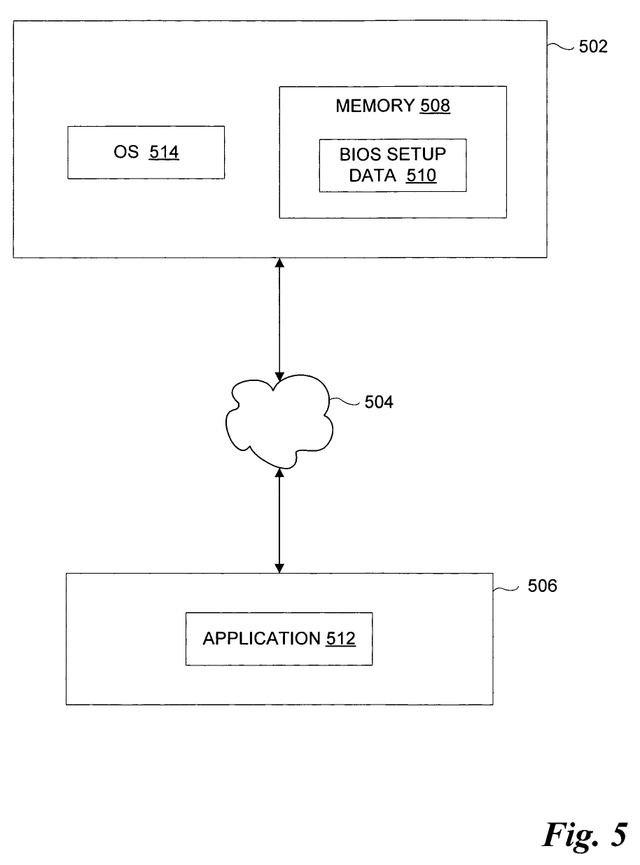

FIG. 5 is shows an embodiment to expose BIOS information to an ACPI aware operating system. A computer system 502 is communicatively coupled to a computer system 506 via network 504. Network 504 includes a local area network (LAN), a wide area network (WAN), the Internet, or any combination thereof. Computer systems 502 and 506 may be communicatively coupled to network 504 using wired connections, wireless connections, or any combination thereof.

Computer system 502 includes an operating system 514 and memory 508. Operating system 514 is an ACPI aware operating system that may access BIOS setup data 510 in memory 508 in accordance with embodiments described herein.

Computer system 506 includes an application 512. In one embodiment, application 512 requests BIOS setup data 510 using a system DLL of OS 514. In another embodiment, computer system 502 includes a client and computer system 506 includes a server. In this particular embodiment, a system administrator may use application 512 to obtain the BIOS setup data 510 of computer system 502.

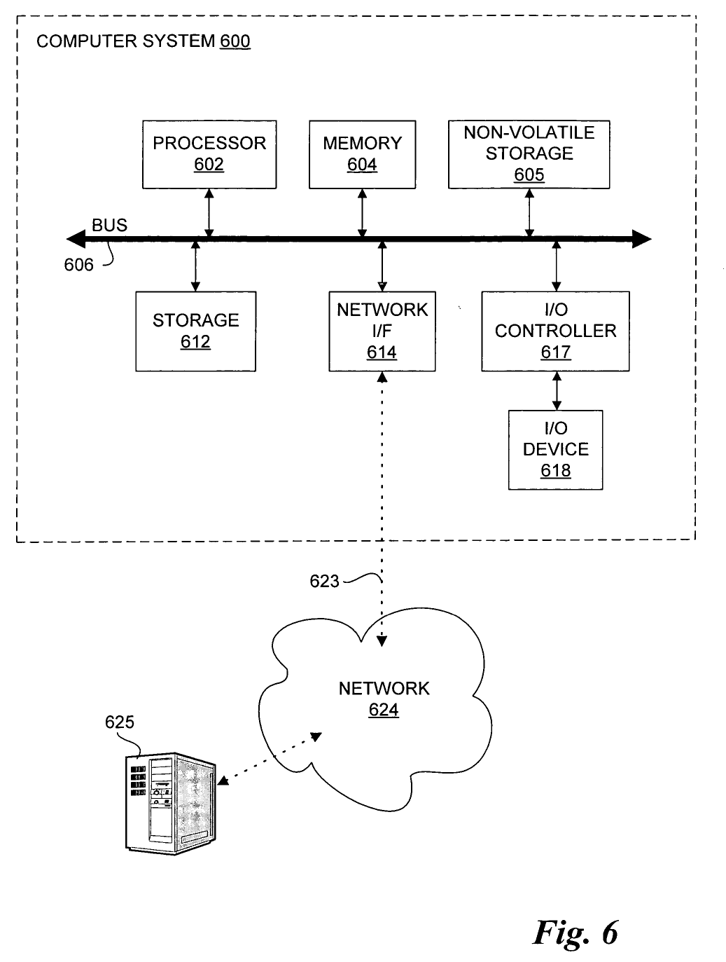

FIG. 6 is an illustration of one embodiment of an example computer system 600 on which embodiments of the present invention may be implemented. Computer system 600 includes a processor 602 coupled to a bus 606. Memory 604, storage 612, non-volatile storage 605, and network interface 614 are also coupled to bus 606. Input/output (I/O) device 618 is coupled to bus 606 via I/O controller 617. Embodiments of computer system 600 include, but are not limited to a desktop computer, a notebook computer, a server, a personal digital assistant, a network workstation, or the like. A typical computer system may include at least processor 602, memory 604, and bus 606 coupling memory 604 to processor 602.

The computer system 600 may interface to external systems through the network interface 614. Network interface 614 may include, but is not limited to, a modem, a network interface card (NIC), or other interfaces for coupling a computer system to other computer systems. A carrier wave signal 623 is received/transmitted by network interface 614. In the embodiment illustrated in FIG. 6, carrier wave signal 623 is used to interface computer system 600 with a network 624, such as a local area network (LAN), a wide area network (WAN), the Internet, or any combination thereof. In one embodiment, network 624 is further coupled to a remote computer 625 such that computer system 600 and remote computer 625 may communicate over network 624.

Processor 602 may include, but is not limited to, an Intel Corporation x86, Pentium®, Xeon®, or Itanium® family processor, a Motorola family processor, or the like. In one embodiment, computer system 600 may include multiple processors. Memory 604 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. I/O device 618 may include a keyboard, a mouse, a display, a printer, a scanner, or the like.

The computer system 600 also includes non-volatile storage 605 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like. Storage 612 includes, but is not limited to, a magnetic hard disk, a magnetic tape, an optical disk, or the like. It is appreciated that instructions executable by processor 602 may reside in storage 612, memory 604, non-volatile storage 605, or may be transmitted or received via network interface 614.

For the purposes of the specification, a machine-accessible medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-accessible medium includes, but is not limited to, recordable/non-recordable media (e.g., read only memory (ROM), random access memory (RAM), magnetic disk storage media, optical storage media, a flash memory device, etc.). In addition, a machine-accessible medium may include propagated signals such as electrical, optical, acoustical or other form of propagated signals (e.g., carrier waves, infrared signals, digital signals, etc.).

It will be appreciated that in one embodiment, computer system 600 may execute operating system software. For example, one embodiment of the present invention utilizes Microsoft Windows® as the operating system for computer system 600. Other operating systems that may also be used with computer system 600 include, but are not limited to, the Apple Macintosh operating system, the Linux operating system, the Unix operating system, or the like.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

1. A method, comprising:
copying Basic Input/Output System (BIOS) setup data to an Advanced Configuration and Power Interface (ACPI) memory region during a pre-boot phase of a computer system;
booting an operating system on the computer system; and
accessing the BIOS setup data during an operating system runtime of the computer system.

2. The method of claim 1, further comprising storing a pointer to the BIOS setup data in a BIOS shadow memory region during the pre-boot phase.

3. The method of claim 2, further comprising searching the BIOS shadow memory region for the pointer during operating system runtime.

4. The method of claim 1 wherein accessing the BIOS setup data comprises:
copying the BIOS setup data from the ACPI memory region to an application memory region; and
accessing the BIOS setup data in the application memory region.

5. The method of claim 1, further comprising receiving a request from an application for the BIOS setup data.

6. The method of claim 5 wherein the application resides on a second computer system communicatively coupled to the computer system over a network.

7. The method of claim 1 wherein in the ACPI memory region comprises an ACPI Type 4 memory region.

8. An article of manufacture comprising:
a machine-accessible medium including a plurality of instructions which when executed perform operations comprising:
copying Basic Input/Output System (BIOS) setup data to an Advanced Configuration and Power Interface (ACPI) memory region during a pre-boot phase of a computer system; and
storing a pointer to the BIOS setup data in a BIOS shadow memory region of the computer system.

9. The article of manufacture of claim 8 wherein the pointer includes a signature to identify the pointer.

10. The article of manufacture of claim 8 wherein execution of the plurality of instructions further perform operations comprising reserving the ACPI memory region.

11. The article of manufacture of claim 8 wherein the ACPI memory region comprises an ACPI Type 4 memory region.

12. An article of manufacture comprising:
a machine-accessible medium including a plurality of instructions which when executed perform operations comprising:
receiving a request from an application for Basic Input/Output System (BIOS) setup data of a computer system;
searching a BIOS shadow memory region of the computer system for a pointer to the BIOS setup data, wherein the pointer identifies a location of the BIOS setup data in an Advanced Configuration and Power Interface (ACPI) memory region of the computer system;
copying the BIOS setup data from the ACPI memory region to an application memory region; and
returning the location of the BIOS setup data in the application memory region to the application.

13. The article of manufacture of claim 12 wherein execution of the plurality of instructions further perform operations comprising accessing the BIOS setup data in the application memory region.

14. The article of manufacture of claim 12 wherein the pointer includes a signature to identify the pointer.

15. The article of manufacture of claim 12 wherein the ACPI memory region comprises an ACPI Type 4 memory region.

16. The article of manufacture of claim 12 wherein the application resides on a second computer system communicatively coupled to the computer system via a network.

17. A system, comprising:
a processor;
at least one Synchronized Dynamic Random Access Memory (SDRAM) device operatively coupled to the processor; and
at least one machine-accessible medium operatively coupled to the processor, the at least one machine-accessible medium including instructions that, when executed by the processor, cause the processor to perform operations comprising:
copying BIOS setup data to an ACPI memory region of the at least one SDRAM device during a pre-boot phase of the system;
receiving a request from an application for the Basic Input/Output System (BIOS) setup data during an operating system runtime of the system;
copying the BIOS setup data from the ACPI memory region to an application memory region of the at least one SDRAM device; and
returning the location of the BIOS setup data in the application memory region to the application.

18. The system of claim 17 wherein the machine-accessible medium further includes instructions that cause the processor to perform operations comprising storing a pointer to the BIOS setup data in a BIOS shadow memory region of the at least one SDRAM device, wherein the pointer includes a signature to identify the pointer.

19. The system of claim 18 wherein the machine-accessible medium further includes instructions that cause the processor to perform operations comprising searching the BIOS shadow memory region for the pointer.

20. The system of claim 17 wherein the ACPI memory region comprises an ACPI Type 4 memory region.

21. The system of claim 17, further comprising a network interface operatively coupled to the processor, wherein the application resides on a computer system communicatively coupled to the system via the network interface.
